(19) United States
(12) Patent Application Publication
(10) Pub. No.: US 2026/0236383 A1
(43) Pub. Date: Aug. 13, 2026

(54) QUALITY ENGINEERING EXTENSION PLATFORM

(71) Applicant: Morgan Stanley Services Group Inc., New York, NY (US)

(72) Inventors: Prashant A. Jasani, Princeton, NJ (US); Brian P. Henderson, New York, NY (US); Dipali Milind Acharya, Mumbai (IN); Anmol A. Alamuru, Bengaluru (IN); Deepika M. Tripathi, Mumbai (IN); Nitu Bharti, Mumbai (IN)

(21) Appl. No.: 19/052,858

(22) Filed: Feb. 13, 2025

(51) Int. Cl. G06F 11/3698; G06F 11/3668

(52) U.S. Cl. CPC G06F 11/3698; G06F 11/3684; G06F 11/3688; G06F 11/3692; G06F 11/3696

(57) ABSTRACT

Systems and methods for implementing a Quality Engineering Extension (QEEX) platform. The QEEX platform decreases automation execution times, provides a central results portal and facilitates Universal CI implementation. The QEEX platform realizes efficiencies in execution time by creating containers on the fly to execute test suites. This enables the ability to scale an execution by the amount of test suites created. At the end of the execution, an embodiment of the present invention utilizes a service to store and process results. A central portal provides the ability to view previous executions, perform analytics and feed results to various systems, models, etc.

### FIELD OF THE INVENTION

The present invention relates generally to implementing a central quality engineering platform and more specifically to a platform that spawns containers, deploys automation applications and test suites on the containers and executes test components in parallel.

### BACKGROUND

Within an organization, software—regardless of the number and type of components—needs to be rigorously tested. The more complicated the software, the more tests that may be needed to run. For example, a financial software application may need to be tested for a number of key features but also edge cases. With the various requirements to test software, an enormous number of test cases may need to execute in a very short time period. Many organizations may be expected to deliver code on a daily or frequent basis across locations and geographies. Given the amount of effort required to support software testing, current systems experience challenges in managing the scale of execution and effectively coordinating the testing and delivering of software.

Currently, engineering teams execute tests in batch jobs or in continuous integration and continuous delivery (CI/CD) pipeline. Oftentimes, each team has its own automation reporting format. In addition, different teams invoke test automation from CI/CD pipelines using different approaches. This results in increased automation execution time with very little or no standardization. The lack of standardization also leads to inconsistencies in results and reports which adversely impacts predictability and downstream processing and analytics.

Accordingly, there is a need for an improved platform that efficiently runs tests in a parallel and optimized manner and further gathers consolidated uniform test results for additional analytics and applications.

### SUMMARY

Systems and methods for implementing an innovative Quality Engineering Extension (QEEX) platform that reduces automation execution times, provides a central results portal and facilitates Universal CI implementation are provided.

According to an embodiment, a computer-implemented system comprises: computer server comprising one or more processors; a centralized database storing testing data and project data; and non-transitory memory comprising instructions that, when executed by the one or more processors, cause the one or more processors to: receive, via a user interface, a test request for a project wherein the test request is onboarded to the quality engineering extension platform and a test manifest file is generated that contains a set of configurations to execute a test suite and wherein the set of configurations comprise a test suite identifier, an automation tool, a results path and a script for each test case; manage, via an application program interface (API), communications relating to a set of microservices to initiate the test suite for the test request on a continuous integration and development tool; determine, via a test executor, a test blueprint for the test suite wherein the test blueprint provisions a set of flexible containers for the test suite and further manages one or more test dependencies; execute, via a test executor, the test suite across the set of flexible containers in a parallel and load balanced manner; monitor, via a central results portal, the test suite during execution across the set of containers wherein the central results portal provides test results and real-time and historical reporting to track and analyze execution status and performance; and provide, via a results processor, the real-time and historical reporting to one or more recipients.

According to another embodiment, a computer-implemented method comprises the steps of: receiving, via a user interface, a test request for a project wherein the test request is onboarded to a quality engineering extension platform and a test manifest file is generated that contains a set of configurations to execute a test suite and wherein the set of configurations comprise a test suite identifier, an automation tool, a results path and a script for each test case; managing, via an application program interface (API), communications relating to a set of microservices to initiate the test suite for the test request on a continuous integration and development tool; determining, via a test executor, a test blueprint for the test suite wherein the test blueprint provisions a set of flexible containers for the test suite and further manages one or more test dependencies; executing, via a test executor, the test suite across the set of flexible containers in a parallel and load balanced manner; monitoring, via a central results portal, the test suite during execution across the set of containers wherein the central results portal provides test results and real-time and historical reporting to track and analyze execution status and performance; and providing, via a results processor, the real-time and historical reporting to one or more recipients.

These and other advantages will be described more fully in the following detailed description.

### BRIEF DESCRIPTION OF THE DRAWINGS

In order to facilitate a fuller understanding of the invention, reference is made to the attached drawings. The drawings should not be construed as limiting the invention, but are intended only to illustrate different aspects and embodiments of the invention.

FIG. 1 is an exemplary system architecture, according to an embodiment of the present invention.

FIG. 2 is an exemplary flowchart, according to an embodiment of the present invention.

FIG. 3 is an exemplary user interface, according to an embodiment of the present invention.

FIG. 4 is an exemplary data structure, according to an embodiment of the present invention.

### DETAILED DESCRIPTION

Exemplary embodiments of the invention will be described in order to illustrate various features of the invention. The embodiments described herein are not intended to be limiting as to the scope of the invention, but rather are intended to provide examples of the components, use, and operation of the invention.

An embodiment of the present invention is directed to a Quality Engineering Extension (QEEX) platform. The QEEX platform decreases automation execution times, provides a central results portal and facilitates Universal CI implementation. The QEEX platform reduces execution time by creating containers on the fly to execute test suites. This enables the ability to scale an execution by the amount of test suites created. At the end of the execution, an embodiment of the present invention utilizes a service to store and process results. A central portal provides the ability to view previous executions, perform analytics and feed quality results to various systems, models, applications, etc.

The QEEX platform provides a consolidated view of automated test results within an entire fleet. In a traditional setup, the output of test results is dispersed over multiple CI jobs in continuous integration and continuous delivery (CI/CD) tools used to automate software builds and testing. The QEEX platform may be designed and implemented for re-use with projects that include automated test suites. The QEEX platform enables accessibility and reporting of automated test results data at multiple levels (e.g., Project, Department, Super Department and Division) within an entity or organization. The QEEX platform may also facilitate automated decision making based on multiple criteria for code deployment to a target environment (e.g., non-PROD and PROD) as part of a chain of fully automated end-to-end CI/CD pipelines.

The QEEX platform ensures quality without manual intervention. For example, the platform may test faster, test on-demand, deploy faster and also retest faster. The QEEX platform provides a consolidated view of test results, over various time periods and across multiple systems. The QEEX platform may report test results in uniform format (e.g., tool and team agnostic) to stake holders to make decisions on the quality of code. The QEEX platform may support multiple test automation tools and various integrations with different systems and services.

An embodiment of the present invention is directed to standardizing the test run process across multiple applications thereby minimizing or avoiding human errors as well as time, effort and resources in addressing the same or similar issues for different teams. The QEEX platform may use dockerized containers for test runs and thereby provide a solution that is highly scalable, reusable, and secure. Docker containers represent a software application package that contains everything needed to run an application including code, runtime, system tools, system libraries, settings, etc.

In addition, QEEX results may be further analyzed and used to create multi-layered reports for Automation result trends and Error Classification trends using data analytics. Automation result trends may provide details of the number of passed and failed test cases via QEEX. Error Categorization trends may refer to data analytics that show the types of errors such as Assertion Errors, Bad Request, Timeout error, etc. for a single or multiple teams. This data may be displayed in various graphical formats, such as last 30 days execution trend, error percentage by categories, error categorization distribution (error type and values). The percentage of each type of error may be provided to help teams to plan better. QEEX also supports an ability to send a consolidated report of the test runs of a particular department via email.

Additional benefits and advantages may include: decreased execution times; central results portal; universal CI implementations and direct use of code from code repositories such as GIT, Bitbucket, etc.

The QEEX platform may be used by any organization or environment to automate and standardize CI processes, provide a faster mean time to resolution (MTTR) and thus a faster and improved delivery.

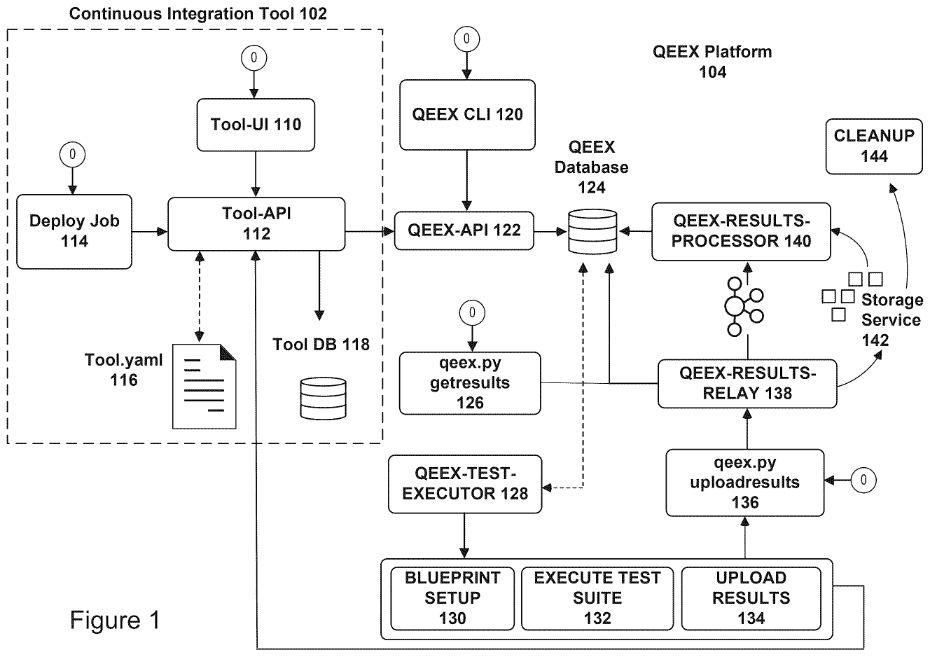

FIG. 1 is an exemplary architecture system diagram, according to an embodiment of the present invention.

According to an embodiment of the present invention, the QEEX platform may represent a central quality engineering platform that enables teams to leverage their automated validation efforts with scalable cloud containers, data auditing and analysis, easy integration to development pipelines and diverse new technologies. The QEEX platform simplifies and accelerates workflows, while providing teams with greater capabilities for efficient automation.

For example, a team may want to run their Automation using non-human ID (as humans/employees may not be permanent team members) and complete the execution for thousands and thousands of test cases within a set time, such as one hour. In this example, the user may onboard their Automation project onto the QEEX platform where the user may update the project, execute tests and then obtain results for the Automation runs triggered using the QEEX platform.

For example, the QEEX platform may provide a unique ability to integrate with a container management platform (e.g., Treadmill) that provides flexible and secure containers from a host in a pool of servers with full support of entity dependencies, e.g., BYOproid, Tam-enabled, automatic LTM configuration, prodperim.

For example, BYOproid may represent a unique identity for a program so the program may run in its own security context. BYOproid is specific/customized to an application. Tam-enabled may indicate that authorization controls across all applications may be enforced by a Tam system. Authorizations to an application may need to be enabled or disabled via this system. Automatic LTM (Local Traffic Manager) configuration may refer to the setup and management of traffic routing and load balancing in network environments. It may be used to optimize, secure and manage application traffic. ProdPerim (The Production Perimeter) may represent a distributed firewall designed to protect and segregate the production environment from non-production network connections.

The container management platform may allow developers to build, test and run software applications. The QEEX platform enables concurrent execution of multiple threads to spawn multiple containers which may subsequently invoke a set of micro-services to perform execution, monitoring, logging and result generation.

The QEEX platform enables the tests to be platform agnostic by using container-based execution in such a way that the dependencies may be handled at a pre-execution layer. For example, the tests run via QEEX may be written in any programming language, e.g., Java, Python, Javascript etc. QEEX's pre-execution layer may deploy dependencies for these programming languages and then seamlessly run the tests in a container.

The QEEX platform supports synchronizing with various applications, platforms and systems including testing applications, etc. (e.g., Train and Test Central). Train may refer to a set of tools, systems, and standards to improve developer productivity while increasing control and quality via a CICD process. Test central may represent an interface for test automation which may be used for internal testing and other processes.

In place of storing results files, the QEEX platform may automatically parse the test results and store them in a database. For example, parsing the test results may involve the QEEX platform processing the content of a report and identifying important details or pieces of information. These analytically chosen details may then be stored in a database. The QEEX platform may run data analysis tools against the data collected and provide insightful information back to the users to further improve execution.

For example, when the QEEX platform receives a test request, it may launch a LINUX container as a PROID, clone a TEST REPOSITORY and trigger the EXECUTABLE that will then run a specific test suite.

An embodiment of the present invention provides a singular method of execution for diverse execution patterns. For example, a single command may invoke various actions including plugging QEEX into a jobs (e.g., CICD Jenkins/TC jobs), scheduling via a batch job, and/or executing a test locally. For example, a single command provided by QEEX may be used to initiate a test from: (1) someone's local system/computer; and/or (2) added within any other automated process or program like a CI/CD pipeline. In essence, a single command may be used to trigger test execution by simply calling the QEEX execution command from varied sources.

According to an embodiment of the present invention, projects may include bundles and test suites, which may be a specific set of tests. Bundle definitions may allow different tests to be run in different scenarios (e.g., post-deployment validation, continuous functional testing, smoke testing, etc.) The system illustrated in FIG. 1 may include various components and interfaces. QEEX Platform 104 represents a scalable test automation execution platform that runs test suites on containers on demand for scalable execution and central results reporting. As shown in FIG. 1, QEEX Platform 104 may interface with a Continuous Integration Tool 102.

An exemplary embodiment may include: QEEX API 122, QEEX Text Executor 128, BluePrint Set-up 130, and QEEX Database 124. A command line interface (CLI) or command prompt represents an application that enables a user to initiate QEEX executions. Other user interfaces may be supported.

QEEX CLI 120 may represent a command line tool that initiates tests from various servers and environments, such as Jenkins/terminal/team city etc.

QEEX API 122 may manage communications of microservices between different components and also provide a user interface for reporting. QEEX API 122 may also represent APIs for various users to initiate the tests. It may also provide a framework (such as Swagger) to maintain/documentation of the API.

QEEX Test Executor 128 may check the status of tests initiated, manage the queue (e.g., N container limit), etc. Once a container is available, QEEX Text Executor 128 may spawn the container and initiate test execution. QEEX Text Executor 128 may manage the containers (which may include a fixed set of containers) and provide the containers sequentially to queue. QEEX Text Executor 128 may check QEEX Database 124 for status of new run requests.

QEEX BluePrints may be used to provide an environment to run tests. For example, once a container is given to test run, depending upon the framework used, BluePrints Setup 130 may provide the environment to run the test and also manage dependencies.

Blueprints may contain shell scripts, which may be used for supported automation tools within QEEX as well as additional utility scripts that may be utilized. For example, to execute a framework that includes tools for automating web browser interactions, java libraries may be needed. Blueprints may download various files, data, libraries, etc. via a shell script defined for the framework. For other testing tools or frameworks, other libraries, e.g., Node libs, may be downloaded by shell scripts. Other scripts defined within Blueprints may include: Blueprint Utilities that sets a status of test run to ‘RECIEVED_BY_CONTAINER’, logs treadmill instance details; clones stash repository and runs validations against script path configured; and logs an event message, exception, updates status, for a test run, etc.

QEEX Database 124 may store and manage runway commands as well as test and project details.

As shown in FIG. 1, a user may submit a request at User Interface (UI) 110 which may then communicate with Continuous Integration Tool API 112 and QEEX API 122. For example, Continuous Integration Tool may include TestCentral, etc.

A user may also submit a request through Deploy Job 114 via a tool that automates building, testing and deployment of software products. This tool may represent a Continuous Integration/Continuous Development (CI/CD) server. A yaml file may be generated at 116. The file may be stored and accessed from Tool Database 118. Tool API 112 may access and communicate to QEEX API 122.

A user may submit a test request at 120, which may then be communicated to QEEX API 122. The request may be stored and managed at QEEX Database 124. QEEX Test Executor 128 may access QEEX Database 124 and initiate and execute a test through BluePrint Setup 130 and Execute Test Suite 132. A request for results may be received at 126 and results may be accessed at Results Relay 138. In this illustration, Results Relay 138 may represent a processing component that passes data or information in a sequential manner.

For example, results may be uploaded via 134 and communicated through Results Relay 138. A user may access results via QEEX Upload Results 136 and Results Relay 138. Upload results may be stored at Storage Service 142 and accessed by QEEX Results Processor 140. Additional processing and cleanup may occur at 144.

QEEX Platform 104 integrates with a central results portal (which may be created using Python, Html and/or other language) to provide real-time and historical reporting via Graphic User Interface (GUI) enabling users to track and analyze execution performance. QEEX Platform 104 may also trigger a notification or communication to a recipient (e.g., a specified distribution list) to provide details.

An embodiment of the present invention provides dependency management capabilities that automatically identify and resolve interdependencies among project components, thus reducing execution time and minimizing errors.

An embodiment of the present invention provides predictive analysis features using Machine Learning (ML models) and Python that utilize historical execution data to forecast potential bottlenecks and recommend optimizations.

Predictability may be linked to dependencies specific to a particular automation. This may involve identifying what dependencies may be required to run a particular test. The dependencies may include various actions including downloading software, accessing data, etc.

An embodiment of the present invention may leverage predictability to manage test execution. For example, an entire test may be broken up into smaller test chunks and then executed in parallel. If a particular test chunk has failed, a user may be directed to the specific failure to address, without having to restart from the beginning. Also, by executing on a set of components in parallel, predictability may be increased as certain components may be exempt from a failure.

An embodiment of the present invention is directed to automatic provisioning for test execution. A test may run on certain hardware components (e.g., computers, processing units, etc.). In addition, the tests may be performed on a set of virtual machines. An embodiment of the present invention may automatically execute tests or tasks in a distributed manner on a set of provisioned machines in parallel. The test results may be received and correlated in a uniform consistent format for further input and/or analysis.

Accordingly, an embodiment of the present invention seeks to minimize resources, reduce time and effort and further isolate failures in a precise and manageable way. Accordingly, results may be analyzed in a structured and consistent manner.

In addition, as more tests are run on a software, it may be more apparent where the code is repeatedly failing. The failure results may be input to an AI Model that may be used to precisely and accurately predict software failures. This enables an entity to focus efforts on predicted failures and thereby minimize risk with an efficient use of resources.

According to an embodiment of the present invention, the platform may integrate with various applications, systems, environments, etc. For example, results may be input to various models, including AI models, to accurately predict failures and facilitate addressing potential issues. In addition, results may serve to provide an accurate audit for compliance before the code reaches production. The results may also be useful for test management tools. An embodiment of the present invention may be directed to providing zero touch deployment. Such deployment may need evidence or support that tests are completed successfully. Other analytics and results may be integrated and may include regression metrics, automation execution metrics, risk analysis, etc.

An embodiment of the present invention provides Error Categorization functionality using databases that classify execution errors into predefined categories for more efficient troubleshooting and resolution. Predefined error categories may include: Internal Server Error; Value Mismatch Error; Mismatch in DB; Fixture file could not be found, etc.

An embodiment of the present invention provides integration capabilities with version control systems, including Bitbucket and Git, to streamline the CI workflow and enhance collaboration among development teams.

Emailable reports and other communications may summarize execution results and insights, facilitating informed decision-making among stakeholders.

An implementation of an API framework (such as Swagger) may allow for seamless integration with third-party applications and services.

An embodiment of the present invention may utilize a cloud storage service automated cleanup and storage of logs and execution artifacts, optimizing resource management.

The QEEX Platform provides support for parallel executions, enabling multiple tasks to run simultaneously, thereby reducing overall execution time.

Customizable execution configurations allow users to define specific parameters and settings tailored to their project needs.

According to an exemplary illustration, QEEX may use PROIDS (e.g., system test IDs) instead of real human IDs for improved maintainability and reliability.

The QEEX Platform represents a universal CI implementation framework that integrates with various development environments and CI tools, ensuring adaptability and scalability.

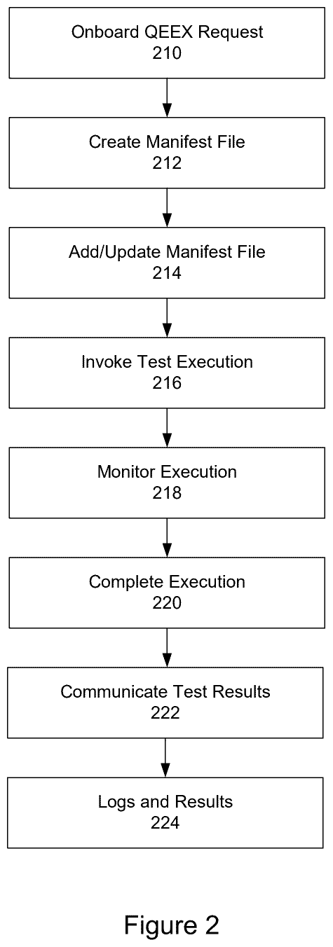

FIG. 2 is an exemplary flowchart, according to an embodiment of the present invention. At step 210, a QEEX request may be onboarded. At step 212, a manifest file may be created. At step 214, the manifest file may be added or updated. At step 216, a test execution may be invoked. At step 218, the test execution may be monitored. At step 220 the test executed may be completed. At step 222, test results may be communicated. At step 224, data logs and the results may be stored and analyzed. While the process of FIG. 2 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 210, a QEEX request may be onboarded. A user may execute a command to onboard a project to the QEEX platform. Project names may be represented as short unique key value identifiers for the user to reference when calling their test suites and bundles. When invoking the execution, searching for results, and/or any high-level function, a user may use the project name to identify their project. Upon onboarding of a project, a prefabricated “qeex.yaml” may be generated in the user's current directory for reference. For example, QEEX may use “qeex.yaml” (default) for executing test suite and/or bundle.

The prefabricated “qeex.yaml” may include a combination of the following fields: application (name of the application that is being tested against); identifier; project (project name to be used to invoke QEEX and configure test suites/bundles); repository url (URL to the repository that holds the automation code); repository branch (branch of the repository that holds the automation code to be cloned); notify emails; test suites (test suite name, automation tool, results path (relative path to the folder where the results will be outputted), script (script to be executed by QEEX and may be relative to the root of the test repository and include parameters)); bundles (bundle name, test suites (list of test suite names to be added to the bundle)).

Test Suites may represent groups of test cases. For example, a single scenario from a feature file could be considered a single test case, where a group of these feature files may be classified as a test suite. Each test suite may get its own container to execute on when triggered. Containers may be destroyed shortly after, but logs may be obtained to review the execution.

Bundles may represent groups of test suites that when executed are executed in parallel containers. For a bundle with 10 test suites, the QEEX platform may create 10 containers for each to run on in parallel to each other. This allows for decreased execution times and improved performance.

At step 212, a manifest file may be created. After the user has on-boarded their project, the user may build a manifest file, e.g., qeex.yaml. This may hold the test suite and bundle configurations along with git repository information (e.g., branch, URL).

At step 214, the manifest file may be added or updated. For example, once the qeex.yaml file is created, a user may update configurations. A user may view the test suite and bundle configurations through a QEEX UI using the project_name after a successful configuration update.

An automated configuration update may be used to automatically update configurations upon check in. As part of the pull request workflow, a successful build may be required. A build process may involve updating the configuration when a user checks in the code to their repository.

When the user creates a pull request, they may need to make sure that their private-pr job is executing a train build. For example, when a user creates a pull request, there should be a pipeline job via Jenkins or Teamcity tools, which may run additional checks before the code can be merged. This ensures that every time code is pushed to a source code management (SCM) repository, the configuration stays current. The user may also run the update from a CLI or other interface.

At step 216, a test execution may be invoked. The test execution may involve a test suite or a bundle on the QEEX platform. For example, a user may specify to run a single test suite that is configured to their project. The user may also run a bundle. Other test options may be available.

The user may view test suites and bundles in the QEEX UI which may include a combination of: project identifier, application name, identifier, create user, create timestamp, update user, update timestamp and notifications. Test suite details may include a combination of: test suite identifier, test suite name, status, automation tool, create user, create timestamp, update user and update timestamp.

At step 218, the test execution may be monitored. When a test request is invoked from a CLI, the interface may demonstrate which test suites are being executed under test request references with each test run identifier assigned to each test suite.

For example, test monitoring information may include: validating user credentials; validating inputs; accessing project configurations; validating bundles; submitting test request; status of test request submitted for execution, etc. Test request references may include: test suite name, test run identifier, etc.

The status of each test run may also be shown on CLI (e.g., after every 15 seconds or other time period) to provide an overall progress of test execution. For example, each test run identified by an identifier may be monitored. Test run status may indicate “configuring container,” “received by container,” “executing test,” etc. “Executing” is the status shown when test scripts are running and on completion it is changed to “Done.” Other status indicators may be implemented.

At step 220 the test executed may be completed. As execution of test suites is completed, test results may be shown on the CLI under a test request and test run execution summary. It may include details such as: total test cases executed, pass percentage, failed test cases, etc.

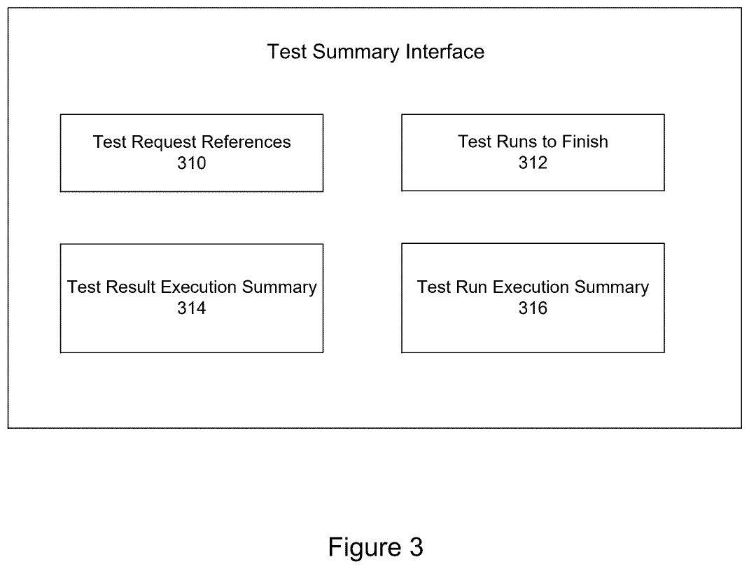

FIG. 3 is an exemplary user interface, according to an embodiment of the present invention. FIG. 3 illustrates an exemplary Test Summary Interface that provides Test Request References 310, Test Runs to Finish 312, Test Result Execution Summary 314 and Test Run Execution Summary 316.

Test Request References 310 may provide a test request identifier and corresponding test suite names and test run identifiers.

Test Runs to Finish 312 may provide details relating to test runs that are in progress. For example, the system may check periodically on the status of the test runs. Status for specific test runs may be provided, e.g., test run has finished with a status of “done.” Test Result Execution Summary 314 may provide status; failed executions; total Test Cases (TC), passed, skipped, failed, pass percentage, and duration.

Test Run Execution Summary 316 may provide test run identifier, test suite name, total TC, passed, skipped, failed, pass percentage and duration.

Warnings may also be provided. For example, a warning may indicate that the test request has more failing test cases than the allowed 100% threshold thereby impacting build result to fail. Other thresholds and metrics may be applied to highlight failure and other indicators or conditions.

At step 222, test results may be communicated. A notification (e.g., email) may be to specific recipients, systems, process, etc. at the end of test request completion. The notification may include details about the test request, such as bundle/test suites executed and pass fail summary. The notification may also include links for test request, test runs which redirects to QEEX UI and test-artifacts which redirects to a Centralized Read-Only file path.

For example, a notification may include: test request details (e.g., test request, bundle, status, environment, total tests, passed, skipped, failures, passing, start timestamp, end timestamp, execution time); test run details (e.g., test run identifier, test suite, status, total tests, passed, skipped, failures, passing, start timestamp, end timestamp, execution time, artifacts link, logs, last #execution result pass percentage, last 100% successful execution date); and group by failure message (e.g., test suite/feature, tests, errors, passed, skipped, failures, test case names, failure message).

At step 224, data logs and the results may be stored and analyzed. Test execution summary of past test requests may be viewed on the QEEX UI by using test request identifier or test run identifier. To access the logs on CLI, a user may use a get-log command with test run identifier. It may display a full QEEX logs associated with the test run. A user may also view this log on the QEEX UI under the test run section.

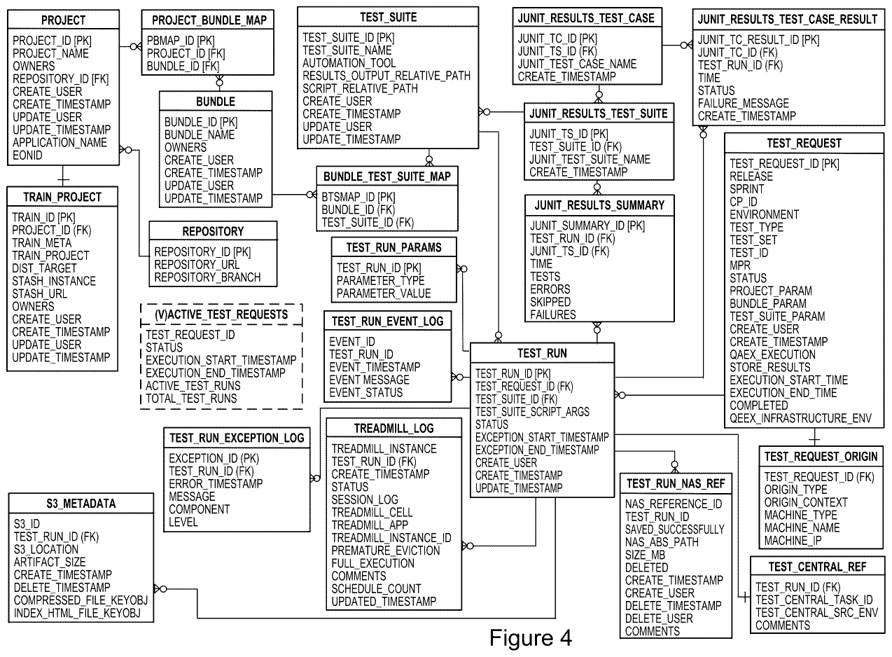

FIG. 4 is a data structure, according to an embodiment of the present invention. Database for QEEX may include a micro-services architecture. A database with microservices architecture may represent a company with many specialized teams like technology, legal, human resources etc. Each team (a microservice) handles a specific task and manages its own data, making the system more organized and flexible. This approach allows independent operations, faster performance, and easier maintenance without affecting other parts of the system.

The user interfaces described may interact and communicate with various users via a communication network. Other users and integrations may be supported.

The system components are exemplary and illustrative, an embodiment of the present invention may interact with additional modules, a combination of the modules described and/or less modules than illustrated. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. Other architectures may be realized.

The illustrated system may be communicatively coupled to various Data Stores as well as remote storages. Data stores may also store and maintain source code, reports, performance data, historical data, etc. These storage components may include any suitable data structure to maintain the information and allow access and retrieval of the information. The storage may be local, remote, or a combination. The storage components may have back-up capability built-in. Communications with the storage components may be over a network or communications may involve a direct connection between the various storage components. The storage components may also represent cloud or other network based storage.

The system may be implemented in a variety of ways. Architecture within the system may be implemented as hardware components (e.g., module) within one or more network elements. It should also be appreciated that architecture within the system may be implemented in computer executable software (e.g., on a tangible, non-transitory computer-readable medium) located within one or more network elements. Module functionality of architecture within the system may be located on a single device or distributed across a plurality of devices including one or more centralized servers and one or more mobile units or end user devices. The architecture depicted in the system is meant to be exemplary and non-limiting. For example, while connections and relationships between the elements of system are depicted, it should be appreciated that other connections and relationships are possible. The system described may be used to implement the various methods herein, by way of example. Various elements of the system may be referenced in explaining the exemplary methods described herein.

Networks may be a wireless network, a wired network or any combination of wireless network and wired network. Networks may further include one, or any number of the exemplary types of networks operating as a stand-alone network or in cooperation with each other. Networks may utilize one or more protocols of one or more network elements to which it is communicatively coupled. Networks may translate to or from other protocols to one or more protocols of network devices. Although Networks may be depicted as one network for simplicity, it should be appreciated that according to one or more embodiments, Networks may comprise a plurality of interconnected networks, such as, for example, a service provider network, the Internet, a cellular network, corporate networks, or even home networks, or any of the types of networks mentioned above.

Data may be transmitted and received via Networks utilizing a standard networking protocol or a standard telecommunications protocol. For example, data may be transmitted using protocols and systems suitable for transmitting and receiving data. Data may be transmitted and received wirelessly or in some cases may utilize cabled network or telecom connections or other wired network connection.

While the figures illustrate individual devices or components, it should be appreciated that there may be several of such devices to carry out the various exemplary embodiments. The system may communicate using any mobile or computing device, such as a laptop computer, a personal digital assistant, a smartphone, a smartwatch, smart glasses, other wearables or other computing devices capable of sending or receiving network signals. Computing devices may have an application installed that is associated with the illustrated system.

Those skilled in the art will appreciate that the diagrams discussed above are merely examples of a system and a method for implementing a central quality engineering platform. Other types and configurations of networks, servers, databases and personal computing devices (e.g., desktop computers, tablet computers, mobile computing devices, smart phones, etc.) may be used with exemplary embodiments of the invention.

Although the foregoing examples show the various embodiments of the invention in one physical configuration, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. The components of the various embodiments may be arranged at any location or locations within a distributed network without affecting the operation of the respective system.

Although examples of servers, databases, and personal computing devices have been described above, exemplary embodiments of the invention may utilize other types of devices whereby a user may interact with a network that transmits and delivers data and information used by the various systems and methods described herein. These devices may further include an electronic memory such as a random access memory (RAM), electronically programmable read only memory (EPROM), other computer chip-based memory, a hard drive, or other magnetic, electrical, optical or other media, and other associated components connected over an electronic bus, as will be appreciated by persons skilled in the art.

In some embodiments, the computing devices may be equipped with an integral or connectable liquid crystal display (LCD), electroluminescent display, a light emitting diode (LED), organic light emitting diode (OLED) or another display screen, panel or device for viewing and manipulating files, data and other resources, for instance using a graphical user interface (GUI) or a command line interface (CLI). The personal computing devices may also include a network-enabled appliance or another TCP/IP client or other device.

The servers, databases, and personal computing devices described above may include at least one accelerated processing unit, such as a GPU or FPGA, and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software. The modules described above may comprise software stored in the memory (e.g., non-transitory computer readable medium containing program code instructions executed by the processor) for executing the methods described herein.

Any suitable programming language may be used in accordance with the various embodiments of the invention. For example, the programming language used may include assembly language, Ada, APL, Basic, C, C++, dBase, Forth, HTML, Android, IOS, . NET, Python, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

The software, hardware and services described herein may be provided utilizing one or more cloud service models, such as Software-as-a-Service (Saas), Platform-as-a-Service (PaaS), Infrastructure-as-a-Service (IaaS), and Logging as a Service (LaaS), and/or using one or more deployment models such as public cloud, private cloud, hybrid cloud, and/or community cloud models.

In the system and method of exemplary embodiments of the invention, a variety of “user interfaces” may be utilized to allow a user to interface with the personal computing devices. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor.

Although the embodiments of the invention have been described herein in the context of a particular implementation in a particular environment for a particular purpose, those skilled in the art will recognize that its usefulness is not limited thereto and that the embodiments of the invention can be beneficially implemented in other related environments for similar purposes.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents. The specification and drawings are accordingly to be regarded as an illustrative rather than restrictive sense.

1. A computer implemented system comprising:
a computer server comprising one or more processors;
a centralized database storing testing data and project data; and
non-transitory memory comprising instructions that, when executed by the one or more processors, cause the one or more processors to:
receive, via a user interface, a test request for a project wherein the test request is onboarded to a quality engineering extension platform and a test manifest file is generated that contains a set of configurations to execute a plurality of test suites and wherein the set of configurations comprise a test suite identifier, an automation tool, a results path, a project name represented as a unique key value identifier, and a script for each test case wherein each test suite represents a group of test cases;
manage, via an application program interface (API), communications relating to a set of microservices to initiate the plurality of test suites for the test request on a continuous integration and development tool;
determine a test blueprint for the plurality of test suites wherein the test blueprint provisions a set of containers for the plurality of test suites and further manages one or more test dependencies wherein each test suite is provisioned to its own container;
receive, via the user interface, an input command comprising a selection to execute one of the plurality of test suites;
execute the selected one of test suites based on the input command;
monitor execution of the selected test suite in its container from the set of containers wherein a central results portal provides test results and real-time and historical reporting to track and analyze execution status and performance;
automatically parse and store the test results in the centralized database, wherein the centralized database is configured to classify any execution errors into predetermined categories based on error type, wherein the predetermined categories comprise at least one of: assertion errors, timeout errors, server errors, or value mismatch errors;
input the real-time and historical reporting to a machine learning model to forecast one or more potential bottlenecks and provide an optimization recommendation;
provide the real-time and historical reporting to one or more recipients; and
destroy the container used by the selected test suite following execution of the test suite.

2. The computer-implemented system of claim 1, wherein the user interface is a command line interface.

3. (canceled)

4. The computer-implemented system of claim 1, the non-transitory memory further comprising instructions that, when executed by the one or more processors, cause the one or more processors to support scalable test execution of each of the plurality of test suites on demand.

5. The computer-implemented system of claim 1, wherein each of the plurality of test suites invokes the set of microservices to execute, monitor, log and generate results.

6. The computer-implemented system of claim 1, wherein each of the plurality of test suites is run in different scenarios comprising post deployment validation, continuous functional testing and smoke testing.

7. (canceled)

8. (canceled)

9. (canceled)

10. (canceled)

11. A computer-implemented monitoring method comprising the steps of:
receiving, by one or more computer processors, via a user interface, a test request for a project wherein the test request is onboarded to a quality engineering extension platform and a test manifest file is generated that contains a set of configurations to execute a plurality of test suites and wherein the set of configurations comprise a test suite identifier, an automation tool, a results path, a project name represented as a unique key value identifier, and a script for each test case wherein each test suite represents a group of test cases;
managing, by the one or more computer processors, via an application program interface (API), communications relating to a set of microservices to initiate the plurality of test suites for the test request on a continuous integration and development tool;
determining, by the one or more computer processors, a test blueprint for the plurality of test suites wherein the test blueprint provisions a set of containers for the plurality of test suites and further manages one or more test dependencies wherein each test suite is provisioned to its own container;
receiving, by the one or more computer processors, via the user interface, an input command comprising a selection to execute one of the plurality of test suites;
executing, by the one or more computer processors, the selected test suite based on the input command;
monitoring, by the one or more computer processors, execution of the selected test suite in its container from the set of containers wherein a central results portal provides test results and real-time and historical reporting to track and analyze execution status and performance;
automatically parsing and storing the test results in the centralized database, wherein the centralized database classifies any execution errors into predetermined categories based on error type, wherein the predetermined categories comprise at least one of: assertion errors, timeout errors, server errors, or value mismatch errors;
inputting the real-time and historical reporting to a machine learning model to forecast one or more potential bottlenecks and providing an optimization recommendation;
providing, by the one or more computer processors, the real-time and historical reporting to one or more recipients; and
destroy the container used by the selected test suite following execution of the test suite.

12. The computer-implemented method of claim 11, wherein the user interface is a command line interface.

13. (canceled)

14. The computer-implemented method of claim 11, further comprising: running the each test suite on demand to support scalable test execution.

15. The computer-implemented method of claim 11, wherein each of the plurality of test suites invokes the set of microservices to execute, monitor, log and generate results.

16. The computer-implemented method of claim 11, wherein each of the plurality of test suites is run in different scenarios comprising post deployment validation, continuous functional testing and smoke testing.

17. (canceled)

18. (canceled)

19. (canceled)

20. (canceled)
